(19) United States
(12) Patent Application Publication
(10) Pub. No.: US 2005/0001207 A1
(43) Pub. Date: Jan. 6, 2005

(54) Polymeric PTC device capable of returning to its initial resistance after overcurrent protection

(75) Inventors: Kyoung-Ri Park, Koonpo (KR); Byoung-Su Jin, Koonpo (KR); Sang-Joon Sung, Seoul (KR); Yu-Seok Kim, Ansan (KR); Seoung-Jung Ryu, Euiwang (KR)

Correspondence Address: OSTROLENK, FABER, GERB & SOFFEN, LLP, 1180 Avenue of the Americas, New York, NY, 10036-8403, US

(73) Assignee: Ceratech Corporation

(21) Appl. No.: 10/903,183

(22) Filed: Jul. 30, 2004

Related U.S. Application Data
(62) Division of application No. 10/045,973, filed on Jan. 10, 2002.

(30) Foreign Application Priority Data
Oct. 12, 2001 (KR) 63113/2001

(51) Int. Cl. H01B 1/00

(52) U.S. Cl. 252/500

(57) ABSTRACT

A polymeric positive temperature coefficient (PTC) thermistor having a particular crystalline structure to allow the resistivity of the crystalline polymer to return to its approximate original level after an overcurrent is applied thereto. Subjecting a polymer to cross-linking, heating the cross-linked polymer at a temperature of a melting point of the polymer or above the melting point of the polymer, and re-crystallizing the heated polymer forms the particular crystalline structure. By doing so, the cross-linking rate of the crystalline polymer is maximized, and the size of the crystals in the crystalline polymer is minimized. Also, the polymer layer having electrodes thereon are cut into units of a desired size before setting and/or hardening thereof, to minimize to formation of irregularities such as stress fractures, microscopic cracks, and the like.

### BACKGROUND OF THE INVENTION

1. Field of the Invention

The present invention relates to polymeric positive temperature coefficient (PTC) devices, in particular, to a polymeric PTC device having a particular crystalline structure allowing the resistance of the crystalline polymer to return to its approximate initial level after an overcurrent is applied thereto.

2. Description of the Background Art

The background art of the present invention relates to polymeric positive temperature coefficient (PTC) devices in general, but particular reference will be made to polymeric PTC thermistors merely for the purposes of explanation.

Typically, a polymeric PTC device (such as a polymeric PTC thermistor) relies upon temperature-induced structural changes in a composite polymer material. The device exhibits low electrical resistance because of the many low-resistance paths created by conductive particles loaded into the composite polymer material. During normal operation, the polymer has a dense, crystalline structure. When current increases to a certain level (e.g., an overcurrent), self-heating causes the polymer to assume an amorphous structure. The separated conductive particles then cause the polymer to exhibit sharply increased resistance. When the overcurrent condition disappears, the polymer regains its crystalline structure, and the reunited conductive particles again provide a current path.

In general, a thermistor is a resistor having a resistance that varies rapidly and predictably with temperature. A thermistor having a positive temperature coefficient (PTC) is generally referred to as a PTC thermistor. A PTC thermistor is a circuit element that can be repeatedly used without requiring frequent replacement for protecting against (i.e., preventing or blocking) excess currents (i.e., overcurrents) in a circuit. The PTC thermistor has an initial resistance prior to blocking an overcurrent, and a subsequent resistance after overcurrent blocking is performed. In general, there are two types of PTC thermistors: a polymeric type and a ceramic type.

A conventional polymeric PTC thermistor advantageously has a lower initial resistance and a faster operation speed compared with a ceramic PTC thermistor. However, ceramic PTC thermistors have been used in particular types of circuits requiring high voltages and/or large currents despite certain advantages of conventional polymeric PTC thermistors.

A method of manufacturing a conventional polymeric PTC thermistor is explained with reference to the drawings as follows.

As shown in FIG. 1A, a polymer material, conductive filler material (e.g., conductive particles), and other additives are mixed together to form a composite polymer, and an extruder (not shown) is used to process the composite polymer into a polymer layer 1. Thereafter, a sheet is created by heat pressurizing a metallic material onto the upper and lower surfaces of the polymer layer 1 to form electrodes 2 thereon. Then, as shown in FIG. 1B, irradiation of an electron beam to the above-described sheet is performed so that the polymeric chain molecules within the polymer layer 1 assume a three-dimensional cross-linked structure, and then setting and/or hardening of the cross-linked sheet is performed. Thereafter, as shown in FIG. 1C, the cross-linked sheet is cut and divided into samples of a desired size. Finally, as shown in FIG. 1D, a conventional polymeric PTC thermistor is completely formed by soldering wires 3 to the electrodes 2.

The polymeric PTC thermistor exhibits low electrical resistance because of the many low-resistance conductive current paths (i.e., “conductive paths”) created by conductive particles in the polymer layer 1. The polymer layer 1 has a dense, crystalline structure during normal operation. When an overcurrent is received by the polymeric PTC thermistor, the temperature thereof increases and the polymer layer 1 undergoes thermal expansion. Temperature-induced structural changes in the polymer layer 1 occur as the conductive particles of the conductive paths are separated, causing the polymer layer 1 to assume an amorphous structure. The separated conductive particles then cause the polymer layer 1 to exhibit sharply increased resistance. As a result, the conductive paths previously formed by the conductive particles within the polymer layer 1 are cut off, and the resistance of the conductive particles increases so that an overcurrent blocking operation is performed. When the overcurrent condition disappears, the polymer layer 1 contracts to regain a crystalline structure, and the reunited conductive particles again provide low-resistance conductive paths.

### SUMMARY OF THE INVENTION

A gist of the present invention involves the recognition by the present inventors of the following problems in the conventional art referring to FIGS. 1A to 1D.

During the conventional manufacturing process, irregularities such as microscopic cracks are formed in the conventional polymeric PTC thermistor, because the sheet comprising the polymer layer 1 and electrodes 2 thereon are cut into units of a desired size after setting and/or hardening thereof. Such irregularities and cracks cause undesirable sparks to be generated when the conventional polymer PTC thermistor operates under high voltage and/or high current conditions, thus degrading the characteristics of the polymeric PTC thermistor.

Also, it was assumed in the conventional art that the intrinsic characteristics of the conventional polymer material inevitably caused the conventional polymeric PTC thermistor to be unstable under high voltage (and/or large current) conditions, and inevitably prevented the conventional polymeric PTC thermistor from returning to its approximate initial resistance level after it operates to block an overcurrent. Thus, ceramic PTC thermistors have been used in circuits requiring high voltages and/or large currents. More particularly, once the conductive particles (forming conductive paths) are separated and cause the polymer layer 1 to exhibit sharply increased resistance, it was believed that the conductive particles could not effectively return to their initial orientations. For example, the resistance of the polymer layer 1 was observed to be significantly higher than its initial resistance even upon the lapse of about one hour after the overcurrent condition disappears. Thus, conventional polymeric PTC thermistors cannot be used in electronic and/or semiconductor devices in a high voltage (and/or high current) environment and requiring rapid repetitive use, as necessary in telecommunications devices and equipment.

Furthermore, for electronic circuits employing a plurality of PTC thermistor elements requiring a constant or specific voltage drop between each of the PTC thermistors, the initial resistance is limited to be within a certain range so that the resistance difference between each pair of conventional polymeric PTC thermistors are minimized after each conventional polymeric PTC thermistor operates. However, even if the initial resistance is made constant or held at a specific level, there are constraints in creating equal voltage drops between the conventional polymeric PTC thermistors, because it is difficult to anticipate how the resistance of each conventional polymeric PTC thermistor will actually change after operating to block overcurrents. Due to these reasons, conventional polymeric PTC thermistors could not be used in certain technical fields, such as telecommunications.

Accordingly, to address and solve at least the above-identified problems of the conventional art, the present inventors developed a polymeric positive temperature coefficient (PTC) device having a particular crystalline structure to allow the resistivity of the crystalline polymer to return to its approximate original level after an overcurrent is applied thereto. Subjecting a polymer to cross-linking, heating the cross-linked polymer at a temperature above a melting point of the polymer, and re-crystallizing the heated polymer forms the particular crystalline structure. By doing so, the cross-linking rate of the crystalline polymer is maximized, and the size of the crystals in the crystalline polymer is minimized. Also, the polymer layer having electrodes thereon are cut into units of a desired size before setting and/or hardening thereof, to minimize to formation of irregularities such as stress fractures, microscopic cracks, and the like.

### BRIEF DESCRIPTION OF THE DRAWINGS

The accompanying drawings, which are included to provide a further understanding of the invention and are incorporated in and constitute a part of this disclosure. Illustrate embodiments of the present invention and together with the description serve to explain the principles of the present invention.

FIGS. 1A to 1D show a conventional manufacturing process of a conventional polymer PTC thermistor.

FIGS. 2A to 2F show a manufacturing process of a polymer PTC thermistor according to the present invention.

FIG. 3 shows an example of a final polymer PTC thermistor product according to the present invention.

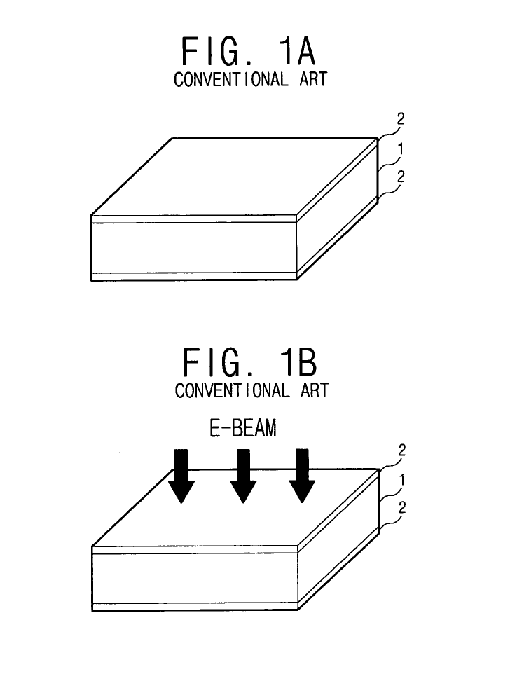

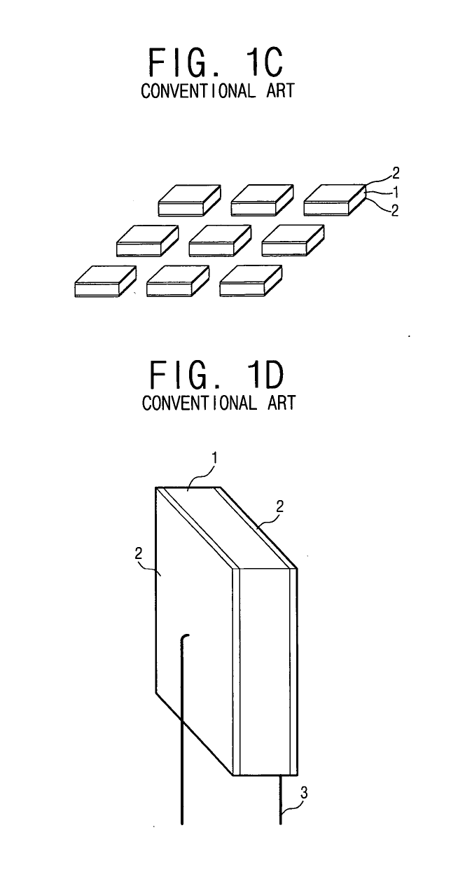

### DETAILED DESCRIPTION OF THE PREFERRED EMBODIMENTS

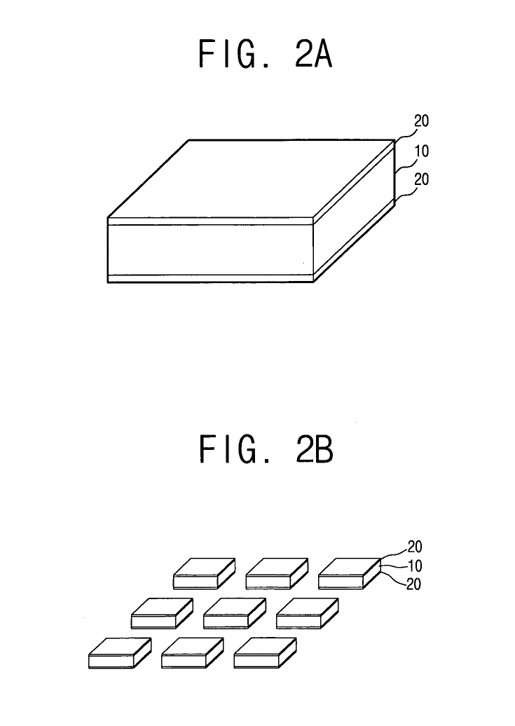

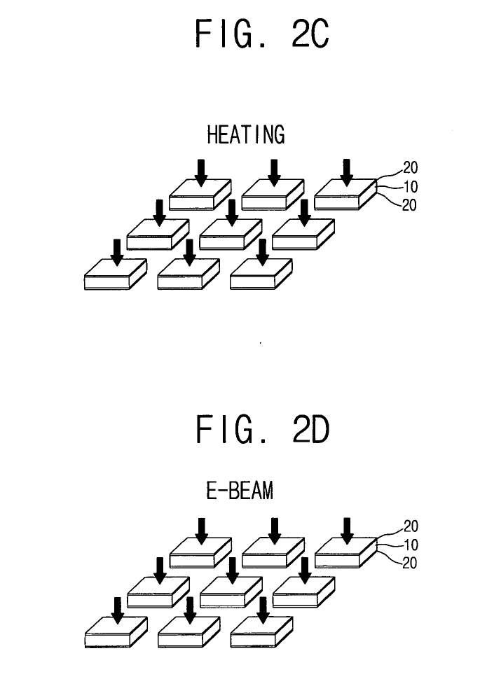

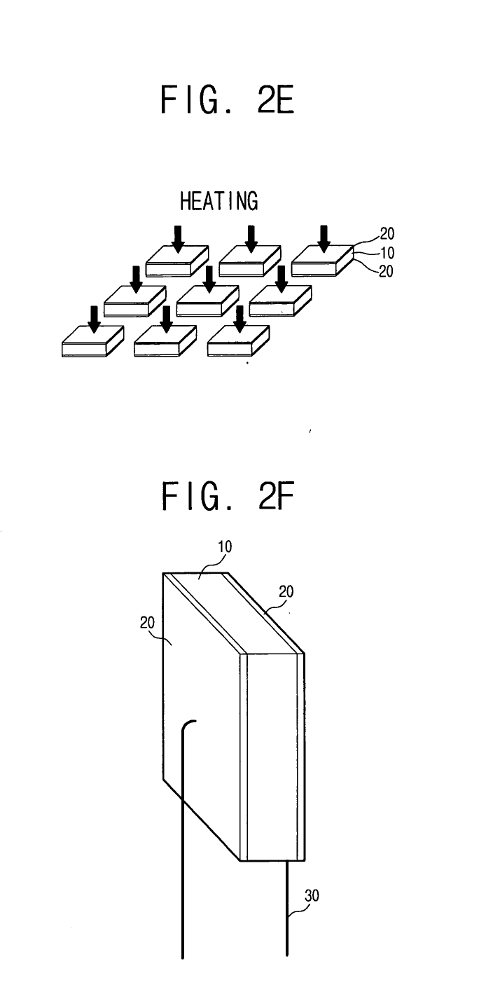

FIGS. 2A to 2F show a manufacturing process of a polymeric positive temperature coefficient (PTC) thermistor according to the present invention.

As shown in FIG. 2A, a polymer material, conductive filler material (e.g., conductive particles), and other additives are uniformly mixed together to form a composite polymer. Then, an extruder (not shown) is used to process the composite polymer into a polymer layer 10 having a sheet form.

Here, the polymer material may be selected from a group comprising polyethylene, co-polymer of polyethylene, polypropylene, ethyl/propylene co-polymer, polybutadiene, acrylate, acrylic ethylene co-polymer, and polyvinylidene fluoride, or any combination of two or more of the above. The conductive filler material (e.g., conductive particles) may be selected from a group comprising nickel powder, gold powder, copper powder, silver coated copper powder, metal alloy powder, carbon black, carbon powder, and graphite, or any combination of two or more of the above. Other additives may include a non-conductive filler material selected from a group comprising an anti-oxidizing agent, salt restrainer, stabilizer, anti-ozonizing agent, cross-linking agent, and dispersant, or any combination of two or more of the above.

It should be noted that one skilled in the art would have understood that the particular types' and specific quantities of the desired polymer material, conductive filler material, and other additives would depend upon the type of characteristics desired from the composite polymer.

When mixing the polymer material, conductive filler material, and other additives together, the mixing must be kept uniform. Also, the mixing temperature and time must be properly controlled so that the conductive filler material will uniformly create conductive paths when the polymeric PTC thermistor operates. If the mixing time is too long, a considerable number of bonds between conductive filler elements are undesirably broken such that sufficient conductive paths cannot be created in the polymeric PTC thermistor and the initial resistance thereof is thus undesirably high. Uniform formation of conductive paths is desirable because it also prevents internal arching from occurring when the polymer expands during overcurrent prevention.

Thereafter, a sheet is created by heat pressurizing a metallic material onto the upper and lower surfaces of the polymer layer 10 to form electrodes 20 thereon. Here, the processing temperature must be carefully controlled. If the surface temperature of the polymer layer 10 is too low, the polymer melting viscosity is also too low and connectivity with the electrodes 20 decreases. Thus, the temperature of the polymer layer 10 should be held above a certain level so that the electrodes 20 are properly attached onto the surfaces of the polymer 10.

Then, as shown in FIG. 2B, the sheet is cut and divided (e.g., using a punching process) into samples of a desired size. Subsequently, setting and/or hardening of the samples are performed. Unlike the conventional method, the cutting and dividing of the sheet are performed before setting and/or hardening of the samples. By doing so, less mechanical stress is applied to the samples compared with the conventional art method, which cuts and divides the sheet after setting and/or hardening. Thus, microscopic cracks and other irregularities can be minimized in accordance with the present invention.

Thereafter, as shown in FIG. 2C, a first heat processing step is performed. Heat processing of the divided samples respectively comprising the polymer layer 10 and electrodes 20 is carried out. This first heat-processing step is performed to improve the thermal stability of the divided samples. In particular, this first heat-processing step further minimizes the stress fractures and other irregularities that may have formed between the polymer layer 10 and the electrodes 20 caused by the expansion and contraction of the polymer layer 10 during the formation of the electrodes 20 on the polymer layer 10, despite the careful temperature control and cutting of the sheet before setting and/or hardening, as explained above.

Thus, the divided samples is preferably heated to a temperature approximately at or above the melting point of the polymer layer 10, and then preferably cooled at approximately room temperature so that the electrodes 20 are attached to the polymer layer 10. Here, the heating is preferably performed at a temperature approximately equally to the melting point of the polymer layer 10 or at a temperature that is about 20° C., 50° C. or 100° C. above the melting point of the polymer layer 10. Also, cooling at about room temperature provides a relatively slow cooling process, as rapid cooling would undesirably cause stress fractures and other irregularities to form in the polymer layer 10 contacting the electrodes 20 due to the quick expansion and contraction therebetween.

Then, as shown in FIG. 2D, high energy electron beams are irradiated onto the divided samples so that the polymeric chain molecules within the polymer layer 10 assume a three-dimensional cross-linked structure. For generating the electron beams, the voltage can be set at about 1 MeV, the current can be set between about 10 mA to 40 mA, and the resulting irradiated energy is between about 10 Mrad to 250 Mrad. Here, various methods can be used for cross-linking the polymeric chain molecules, including chemical cross-linking, gamma ray irradiation, or the like. However, in order for the polymeric PTC thermistor to operate and withstand high voltages, a high cross-linking rate is required, and thus using electron beams that generate high energy is most effective.

Finally, as shown in FIG. 2E, a second heat processing step is performed. Namely, after the cross-linking process, the cross-linked samples are re-heated at a temperature approximately at or above the melting point of the polymer layer 10, and rapid cooling thereafter is performed. Here, the re-heating is preferably performed at a temperature that is at a temperature approximately equal to the melting point of the polymer layer 10 or about 30° C., 50° C. or 100° C. above the melting point of the polymer layer 10, so that the polymer melt viscosity is sufficiently lowered to allow the polymer chain molecules to reach the crystal growth point. This high temperature re-heating step further crystallizes the polymer layer 10 and causes cross-linking of additional polymeric chain molecules that were not cross-linked during the irradiation of electron beams so that a more stable crystalline structure of the polymer layer 10 is obtained. The presence of a cross-linking agent, if included as an additive when forming the composite polymer, further enhances chemical cross-linking and allows a more elaborate cross-linked structure for the polymer layer 10 so that heat deformation is prevented.

Also, high temperature re-heating allows the size of crystals in the polymer layer 10 to be formed as small as possible so that the crystallization degree of the overall polymer is made uniform. Compared to the conventional polymer having crystals of a larger size, the present invention polymer (with smaller crystals) expands at a lower temperature and thus the polymeric PTC thermistor can operate more quickly, and overcurrent protection can begin at a lower temperature. Accordingly, the present invention allows the flow of the conductive path to be limited at a temperature prior to the non-crystalline regions becoming fully amorphous, and facilitates the crystalline polymer to contract and quickly return to its initial state.

Additionally, as the crystal size is minimized, a larger number of smaller crystals are present within the polymer layer 10 (compared with a smaller number of large crystals in the conventional polymer layer 1), and thus the density of the crystalline structure in polymer layer 10 is greater than that of the conventional polymer layer 1. As a result, the overall amount of non-crystalline areas between the crystals is reduced, and thus the conductive particles dispersed within the polymer layer 10 can more easily return to their original orientations even when expansion and contraction of the polymer layer 10 are performed rapidly and continuously.

To achieve a minimal crystalline structure for the polymer layer 10, a rapid cooling step needs to be performed. Here, the previously set temperature of about the melting point of the polymer layer 10 or about 30° C., 50° C., or 100° C. above the melting point of the polymer layer 10 is decreased to about room temperature, 10° C., or 0° C. during a period of about 5 minutes, 1 minute or 10 seconds.

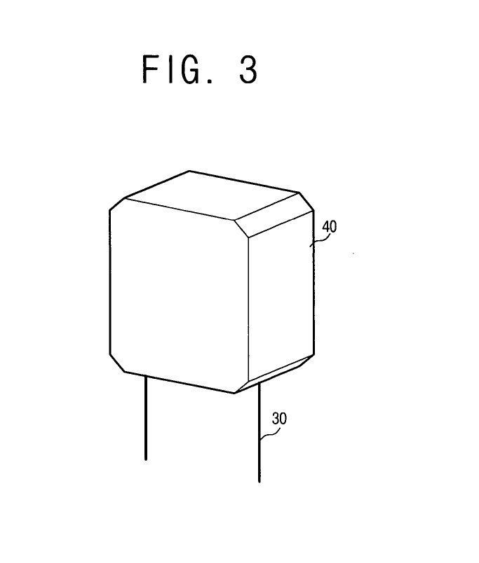

FIG. 2F shows wires 30 electrically attached to the electrodes 20 to complete the formation of a polymeric PTC thermistor according to the present invention. Additionally, insulation around the body of the polymeric PTC thermistor may be formed as shown in FIG. 3. FIG. 3 shows an example of a final polymeric PTC thermistor product of the present invention. An epoxy molding 40 is formed to encapsulate the electrodes 20 having a polymer layer 10 therebetween, while the ends of the wires 30 protrude out and are exposed from the epoxy molding 40. The epoxy molding 40 acts as an insulation protection layer and further enhances the polymer PTC thermistor of the present invention.

An experiment to compare the characteristics of the polymeric PTC thermistor of the conventional art and that of the present invention was conducted. Table 1 shows the electrical resistance characteristics of a conventional polymeric PTC thermistor before and after overcurrent protection. Table 2 shows the electrical resistance characteristics of the polymeric PTC thermistor according to a preferred embodiment of the present invention before and after overcurrent protection.

The experiment was carried out on ten (10) samples of a conventional polymeric PTC thermistor, and on ten (10) samples of a polymeric PTC thermistor according to the present invention. By applying 600 V and 3 A (i.e., applying a high voltage overcurrent situation), each sample naturally turned on within seconds and was turned off after the lapse of 60 seconds. The resistance before and after the high voltage overcurrent situation was measured to obtain an initial resistance and a subsequent resistance. A rate of resistance variation from the initial resistance to the subsequent resistance was obtained as a percentage value. The above steps were repeated fifty (50) times for each sample and the average of the initial resistance, subsequent resistance, and rate of resistance variation were obtained and put into a table as follows.

TABLE 1
(Conventional art)

| | Initial | Subsequent | Rate of resistance |
|---|---|---|---|
| Sample No. | Resistance (Ω) | resistance (Ω) | variation (%) |
| 1 | 7.93 | 23.90 | 201.39 |
| 2 | 7.75 | 22.60 | 191.61 |
| 3 | 7.29 | 22.40 | 207.27 |
| 4 | 7.91 | 22.40 | 208.47 |
| 5 | 7.94 | 24.20 | 204.79 |
| 6 | 7.76 | 23.10 | 197.68 |
| 7 | 7.83 | 22.60 | 188.63 |
| 8 | 7.73 | 23.50 | 204.01 |
| 9 | 7.73 | 22.50 | 191.07 |
| 10 | 7.63 | 24.30 | 218.48 |
| Total average | 7.73 | 23.35 | 201.34 |

TABLE 2
(Preferred embodiment)

| | Initial | Subsequent | Rate of resistance |
|---|---|---|---|
| Sample No. | Resistance (Ω) | resistance (Ω) | variation (%) |
| 1 | 8.04 | 8.20 | 1.99 |
| 2 | 8.00 | 8.11 | 1.37 |
| 3 | 8.01 | 8.09 | 1.00 |
| 4 | 8.06 | 8.14 | 0.99 |
| 5 | 8.03 | 8.11 | 1.00 |
| 6 | 7.99 | 8.13 | 1.75 |
| 7 | 8.01 | 8.03 | 0.25 |
| 8 | 8.07 | 8.21 | 1.73 |
| 9 | 7.84 | 8.03 | 2.42 |
| 10 | 7.99 | 8.13 | 1.75 |
| Total average | 8.00 | 8.12 | 1.43 |

Referring to Table 2, Sample No. 1, it can be seen that the rate of resistance variation before and after overcurrent protection for the polymeric PTC thermistor of the present invention was 1.99%. The average rate of resistance variation for ten samples of the present invention was found to be 1.43%, while that of the conventional art samples was 201.34% (see Table 1). Remarkably, the rate of resistance variation for the present invention can be considered to be next to nothing compared to that of the conventional art.

As can be clearly seen in the above results, the polymeric PTC thermistor according to the present invention has far superior resistivity characteristics over that of the conventional art. In particular, the polymeric PTC thermistor of the present invention allows the electrical resistance to quickly return to its approximate initial resistance level after overcurrent protection. As such, the polymeric PTC thermistor according to the present invention can be used in various fields of technology, especially in electronic and/or semiconductor devices requiring rapid repetitive use, as necessary in telecommunications devices and equipment. For example, the present invention polymeric PTC thermistor can be applied to the so-called “ring line” and “tip line” in telecommunications, and the voltage drop generation due to a resistance differences between circuit elements (i.e., the polymeric PTC thermistors) after overcurrent protection can be minimized due to the characteristics of the present invention.

Although the present invention has been described in an embodiment of a polymeric PTC thermistor, one skilled in the art at the time of the present invention would have understood that the manufacturing process of the present invention may be employed in various other types of polymeric PTC devices for circuit and/or semiconductor device applications used in overcurrent protection.

This specification describes various illustrative embodiments of a method and device of the present invention. The scope of the claims is intended to cover various modifications and equivalent arrangements of the illustrative embodiments disclosed in the specification. Therefore, the following claims should be accorded the reasonably broadest interpretation to cover modifications, equivalent structures, and features that are consistent with the spirit and scope of the invention disclosed herein.

1-10. (canceled).

11. A method of forming a polymeric positive temperature coefficient (PTC) device, the method comprising:
providing a composite polymer layer;
forming at least one pair of electrodes on an upper surface and a lower surface the polymer layer to obtain an intermediate structure;
dividing the intermediate structure into samples of a desired size;
subjecting the samples to cross-linking; and
re-crystallizing the samples to form a polymeric positive temperature coefficient (PTC) device.

12. The method of claim 11, further comprising a step of first heating processing the samples prior to cross-linking.

13. The method of claim 12, wherein the first heat processing comprises a step of heating at a temperature that is approximately between a melting point of the polymer layer to 100° C. above the melting point of the polymer layer, and a step of relatively slow cooling at about room temperature.

14. The method of claim 11, further comprising a step of second heat processing the samples after cross-linking.

15. The method of claim 14, wherein the second heat processing comprises a step of heating at a temperature that is approximately between a melting point of the polymer to 100° C. above the melting point of the polymer layer, and a step of relatively rapid cooling at a temperature that is approximately between room temperature to 0° C. for no more than five minutes.

16. The method of claim 11, wherein the composite polymer layer comprises a polymer material, a conductive filler material, and at least one other additive.

17. The method of claim 11, wherein the cross-linking is achieved by irradiating the samples and/or performing chemical cross-linking.

18. The method of claim 17, wherein the irradiating is performed by an electron beam.

19. The method of claim 11, wherein the re-crystallizing is performed by cooling the samples to minimize a size of the crystals.

20. The method of claim 11, wherein the formed polymeric PTC device is a polymeric PTC thermistor.
